(19) United States
(12) Patent Application Publication
(10) Pub. No.: US 2012/0271667 A1
(43) Pub. Date: Oct. 25, 2012

(54) SYSTEM AND METHOD FOR THE REDEMPTION OF PRODUCTS AND SERVICES

(76) Inventor: Brad Gregory Serling, San Francisco, CA (US)

(21) Appl. No.: 13/369,931

(22) Filed: Feb. 9, 2012

Related U.S. Application Data
(60) Provisional application No. 61/441,176, filed on Feb. 9, 2011.

(51) Int. Cl. G06Q 30/02; G06Q 10/02

(52) U.S. Cl. 705/5

(57) ABSTRACT

The invention disclosed herein is directed to a system and method of facilitating a user's redemption of goods, services and/or promotional materials comprising a user interface into which the user may input data from a bar code or other data associated with an event admissions ticket. The system and method may then identify the bar code or other data, and allow the user to access the goods, services or promotional materials. The event admissions ticket may be from a concert, sporting event, convention or other activity. Certain embodiments of the invention, after entering the bar code from the event admissions ticket, users of the system and method may download from the Internet or other communications network, or otherwise gain access to product, services or other promotional materials such as audio products, video products, or coupons including, but not limited to, music, music videos, movies, games and/or discount coupons.

### CROSS REFERENCE TO RELATED APPLICATION

This application claims priority to, and the benefit of, U.S. Provisional Patent Application Ser. No. 61/441,176, filed Feb. 9, 2011, entitled “System and Method for the Redemption of Products and Services,” the entirety of which is incorporated herein by reference.

### FIELD OF THE INVENTION

The present invention relates to a system and method for redeeming products, services, promotional and/or other materials. More particularly, the present invention relates to a system and method for redeeming products, services, promotional and/or other materials over the Internet and/or other communications networks. In one embodiment, the present invention relates to a system and method for redeeming products, services, promotional and/or other materials utilizing certain data contained in the bar code from an event admissions ticket.

### BACKGROUND OF THE INVENTION

The utility of the data contained in a bar code printed on an event admissions ticket has typically been limited to the single use of proving the validity of the ticket in order to gain entry into an event. Such events may include sporting events, concerts, movies, plays, conventions, speeches or other entertainment, professional, business or other activities. In this regard, the bar code on an admissions ticket typically comprises data which is unique to the particular event such as, for example, the date of the event, a seat location, pricing information, and/or other information which may be pertinent to the particular event.

Once an admissions ticket has been scanned at the venue of the particular event, the ticket holder generally will either retain the ticket as memorabilia of the event, or throw the ticket away. Either way, the usefulness of the bar code data has usually been exhausted after a single use. However, it has been recognized by the inventor that the characteristics of the bar code contained on an admissions ticket which stem from the unique nature of the data contained therein may continue to be utilized after the admissions ticket has been used for admission to the event.

One such utility would be to use the same unique bar code to permit the bearer of the admissions ticket to obtain access to additional goods, services, promotional materials or other benefits beyond admission to the event itself. In one example, by entering the bar code information into an online site or personally scanning the bar code with a bar-code-scanning mobile phone application, the bearer of the admissions ticket would be able to download from the Internet or other communications network, music by the artist who performed at the event related to the admissions ticket.

In this regard, however, current systems which permit the redemption of promotional and other materials from the Internet have not been directed to utilizing the bar code or other product identifiers which is unique to a previously purchased product or service such as an event admissions ticket. In such existing systems, information generally utilizes code-bearing cards or direct code transmissions in order to convey redemption codes. For example, Dropcards™ provides a service in which a credit-card-type device is distributed to a user so that the user may redeem music downloads from the Dropcards™ website. The website URL and “access code” are listed on the back of the card so that the recipient of the card may enter the code into an interactive website and redeem the purchased music from the Internet. Unlike the admissions ticket, the credit-card-type device serves no other apparent function other than to display the access code and URL.

In another existing system, iTunes® uses a similar device in which the user scratches off a section of the back of the card to reveal the code which will be inputted in the iTunes® Store. However, as with the Dropcards™ system, the credit-card-type device serves no other apparent function other than to display the access code and URL.

Thus, there exists the need for a system and method which utilizes the unique data contained in a device, such as a bar code, and which is associated with a previously purchased product or service, to provide the bearer of such a device with additional products, services or other benefits. In one example, the industry of promotion redemption by way of the Internet or other communications networks has yet to combine the concept of the instant invention with unique bar codes from event admissions tickets. Therefore, there exists a need to combine these concepts in the event admissions ticket industry as a means to further promote ticket sales or otherwise add value to the purchase of such tickets. In addition, there exists a need to combine these various concepts by providing a system and method for utilizing bar code data from an event admissions ticket to redeem promotions and access content in a variety of ways, such as, for example, entering the bar code numbers into a website, utilizing a bar-code-scanning mobile phone application, using imaging or camera devices, and/or using other user interfaces and communications networks.

### SUMMARY OF THE INVENTION

The present invention is a system and method for facilitating a user's redemption of goods, services, promotional and/or other materials by way of locating a bar code on an event admissions ticket and entering the code using an interactive website, a mobile phone application, and/or other combinations of user interfaces and communications networks. In turn, the interactive website, mobile phone application, and/or other user interface and communications network, determines the validity of the code and provides the user with the ability to download or otherwise obtain the goods, services and/or promotional materials thereafter. The system and method of the invention may also be configured to limit the number of times an individual bar code may be used to gain access to the goods, services or promotional materials which are to be redeemed.

In one embodiment, the invention comprises a system for facilitating a user's redemption of goods, services, promotional and/or other materials. The user interface may comprise, but is not limited to, a website found on the Internet, a mobile phone application with access to the Internet or other communication network which may include or interface with a data input device, such as a bar code scanner, photographic interface, or other device or system through which data may be input or which may detect data, such as an alphanumeric code, a bar code, a CR code, or image. For example, a user of the system may input data into the user interface from a bar code which may be found on an event admissions ticket. Alternatively, the data may be input through a bar code scanner or through a CR code reader.

Additionally, the system of this invention may be used in connection with any type of event including, but not limited to a concert, sporting event, convention or other activity. The system may then identify the bar code or other data as valid therein allowing access to the goods, services, promotional and/or other materials.

Another embodiment of the invention comprises a method for facilitating a user's redemption of goods, services and/or promotional materials. The method may comprise the steps of: (i) receiving through a computerized user interface data, such as from a bar code associated with an event admissions ticket; (ii) identifying the bar code data as valid data; and (iii) allowing the user to obtain access to the goods, services and/or promotional materials. The user interface may comprise, but is not limited to, a website found on the Internet, a mobile phone application with access to the Internet or other communication networks, a bar code scanner or photographic interface, or other device which may detect the bar code image. As with the system of the present invention, the event admissions ticket may be associated with any event including but not limited to a concert, sporting event, convention or other activity.

### BRIEF DESCRIPTION OF THE DRAWINGS

FIG. 1 depicts a block diagram of an embodiment of the system of the present invention.

FIG. 2 depicts a block diagram of an embodiment of the method of the present invention.

Appendix A comprises select pages from the www.livephish.com website, the entirety of which is incorporated herein by reference.

### DETAILED DESCRIPTION OF THE EMBODIMENTS

It is to be understood that the figures and descriptions of the present invention have been simplified to illustrate elements that are relevant for a clear understanding of the present invention, while eliminating, for the purposes of clarity, many other elements which may be found in the present invention. Those of ordinary skill in the pertinent art will recognize that other elements are desirable and/or required in order to implement the present invention. However, because such elements are well known in the art, and because such elements do not facilitate a better understanding of the present invention, a discussion of such elements is not provided herein.

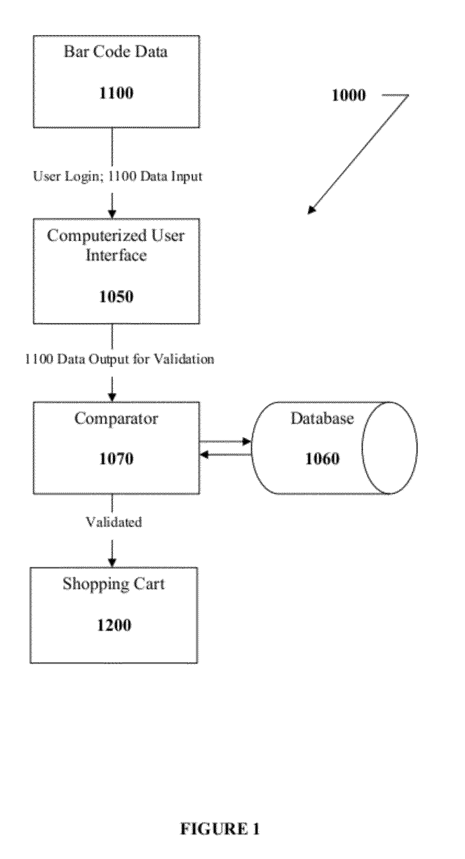

Turning now to FIG. 1 there is shown an embodiment of system 1000 of the instant invention. System 1000 of the invention comprises computerized user interface 100. Computerized user interface 1050 may comprise, but is not limited to, a website found on the Internet, a mobile phone application with access to the Internet or other communications network, and data input device for inputting a code or other designation. For example, the data input device may comprise any data input device or method including, but not limited to, a bar code scanner, a photographic or other imaging interface, data entry through a computer or internet interface, or other device which may detect data such as alpha numeric characters, symbols, bar codes, QR codes, or other perceptible designations or images.

In the embodiment depicted in FIG. 1, one such website into which computerized user interface 1050 may be incorporated may be found at www.LivePhish.com. See Appendix A at A-1 through A-8. After logging into user interface 1050, and once bar code, or other designation or image 1100 is identified on an event admissions ticket by a user, bar code 1100 may be entered into user interface 1050. See Appendix A at A-3 through A-6. User interface 1050 then validates bar code 1100 by utilizing comparator 1070 to compare bar code 1100 data to database 1060. Database 1060 generally comprises a database of known valid bar codes associated with legitimately issued admissions tickets for an event. Once the ticket is identified as legitimate or “validated,” the user is granted access to the products, services or other promotional materials to be redeemed. Optionally, the user may then add the product, service or other promotional material to be redeemed to shopping cart 1200, directly download or otherwise access or take possession of such redeemables. See Appendix A at A-7.

In one embodiment of system 1000, the user may be offered an upgraded product, service, or other promotional material for an additional cost. If the user elects to upgrade the redeemables, the user may be prompted for additional billing and/or shipping information. The order may then be confirmed, a receipt generated and the product or service downloaded or otherwise delivered to the user.

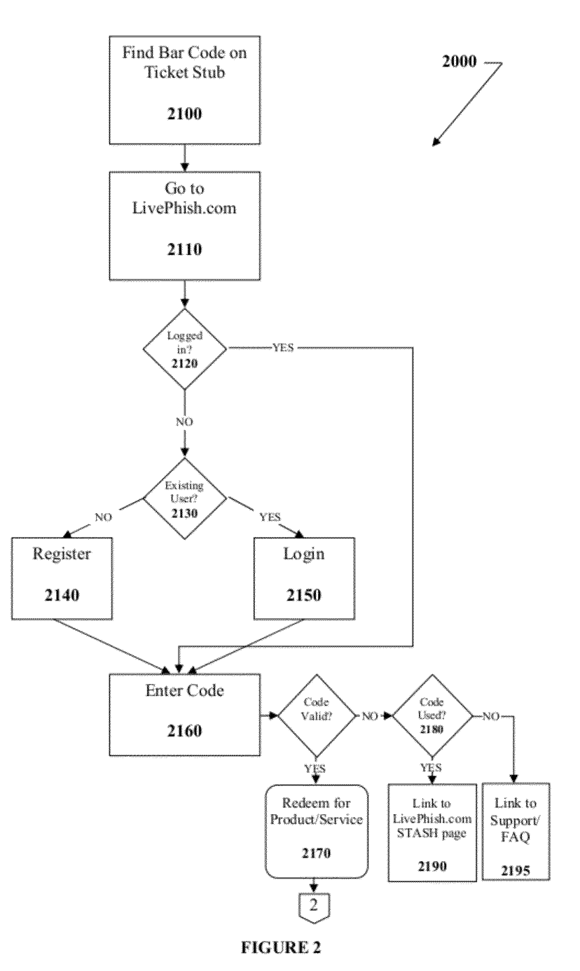

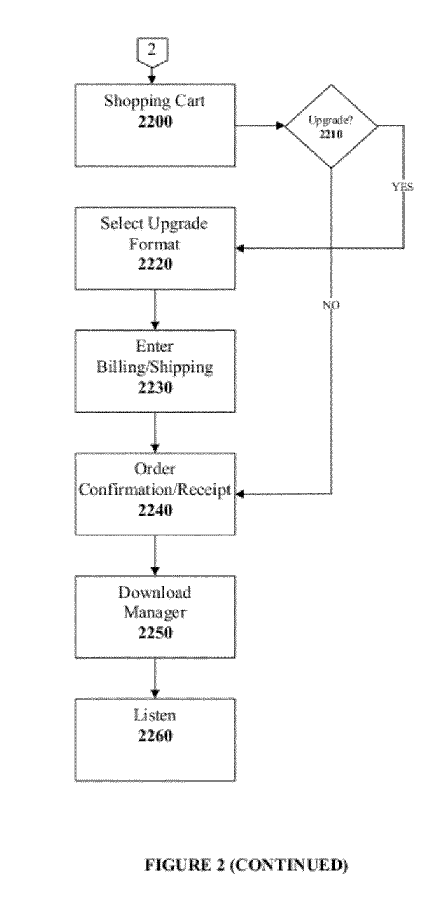

Turning now to FIG. 2 there is shown an embodiment of the method of the present invention 2000. Bar code 1100 is identified on the admission ticket at 2100. In one embodiment of the invention, a user may redeem goods, services or other promotional materials by method 2000 only after bar code 1100 has been scanned or otherwise used to gain entry into an event.

Using the method of FIG. 2, the user may log on to system 1000 through user interface 1050 through a website such as, for example, www.LivePhish.com at step 2110. Appendix A at A-1 through A-8. While www.LivePhish.com may be utilized to access system 1000 and input bar code 1100 into system 1000, it should be noted that the method of FIG. 2 may utilize any website or other interface such as, for example, a mobile phone application with access to the Internet or other communications network, a bar code scanner or photographic interface, or other device which may detect a bar code, image or other designation. In addition, the method of FIG. 2 may be configured to accept and verify bar code 1100 and comprise functionality for downloading or otherwise delivering the redeemables to the user or user's designee.

Turning again to the embodiment of the invention depicted in FIG. 2, once the user has entered the website at 2110, the user may be directed to log in to system 1000 at 2120. See Appendix A at A-3. If the user is determined to be logged into system 1000 at 2120, the user may be directed to enter bar code 1100 at 2160. See Appendix A at A-4 through A-6.

If the user is determined not to be logged into system 1000 at 2120, a new user may be prompted at 2130 to register to access system 1000 at 2120, while an existing user may be prompted at 2130 to log into system 1000 at 2150. See Appendix A at A-3. In one embodiment of the invention, registration at 2140 may require that the user provide the user's name and address, a screen name, password, and/or email address before being granted access to system 1000.

After the user has successfully passed steps 2120, 2130, 2140, and/or step 2150, the user may then enter bar code 1100 into the website at 2160 using bar code 1100 from step 2100. See Appendix A at A-6. If bar code 1100 is identified by system 1000 as being valid, the user may be granted the ability to redeem for a product, service or other promotional material at 2170. If bar code 1100 is identified by system 1000 as not being valid, system 1000 may also determine if bar code 1100 was already used at 2180. If bar code 1100 is identified by system 1000 as already being used, the user may be directed to the www.LivePhish.com STASH page at 2190 or elsewhere on the site. See Appendix A at A-8. Alternatively, the user may be directed back to any website linked to a command promoted by a used bar code 1100. If bar code 1100 was not previously used, the user may be directed to a Support/FAQ site at 2195. In one embodiment, step 2195 may assist the user in determining why the user received an error that the code was either invalid and/or not used.

Once the user reaches 2170 to receive the redeemables, the user may be directed to shopping cart 1200 at step 2200 to execute the redemption process. See Appendix A at A-7. The user may optionally be given the opportunity to upgrade the redeemables at 2210. In this regard, the user may be offered the opportunity to purchase upgraded, substitute or additional items from the website or other source. If the user chooses to upgrade or otherwise modify the redemption at 2210, the user may be directed to select the upgrade format or other modification to the redeemables at 2220 and to enter billing and shipping information at 2230. The user may then be directed to order confirmation and receipt at 2240 to finalize the transaction. If the user chooses not to upgrade or otherwise modify the redeemables at 2210, the user may be directed to order confirmation and receipt page at 2240 to finalize the transaction.

If the redeemable is, for example, digital audio, video or other downloadable content, the user may access the download manager at 2250 to be able to view, listen or otherwise receive the product, service or other promotional material. In certain embodiments of the invention, download manager 2250 may comprise any program that enables a user to listen or view digital media or other content on the user's personal computer or other device. Once the content has been downloaded, the user may then be able to listen, view or otherwise utilize the downloaded content at 2260.

In one embodiment of the invention, music, music videos, photographs, movies, programming, games or other digital media may be the content which is redeemed in downloadable form. However, the user may also be able to redeem any other good, service or promotional material regardless of physical form including, but not limited to, coupons, CDs, apparel, printed and promotional materials as well as other goods and/or services.

In addition, information contained in bar codes and other identifying means found on articles other than admissions tickets may be utilized with the present invention. For example, bar codes found on certain retail products may also be utilized in a similar fashion. In this regard, bar codes contained on retail products typically lose their usefulness after the product has been scanned at checkout at a retail store. The data contained on the bar code of a retail product usually contains product and pricing information enabling the retailer to accurately charge a customer for the product as well as track the retailer's inventory of the product.

However, the system and method of the present invention may also enable the bar code or other data which is unique to the particular product, to be used in redemption programs similar to those employed with event admissions tickets. For example, all automobiles purchased in the United States bear a vehicle identification number, also referred to as the “VIN”. Each VIN is unique to a particular automobile and has no use other than to identify a specific automobile. In this regard, the VIN could be utilized by the system and method of the instant invention wherein the purchaser may enter the VIN into the system of the invention to receive, for example, a coupon for a free tank of gas.

While the foregoing invention has been described with regard to particular embodiments of the invention disclosed herein, and certain details have been set forth for the purpose of illustration, it will be apparent to those skilled in the art without departing from the spirit and scope of the invention, that the invention may be subject to various modifications and additional embodiments, and that certain of the details described herein can be varied considerably without departing from the basic principles of the invention. Thus, such modifications and embodiments are also intended to fall within the scope of the appended claims.

What is claimed is:

1. A system for facilitating a user's redemption of goods, services or promotional materials comprising:
a user interface into which said user may input data from data associated with an event admissions ticket, wherein said system identifies said data, and allows said user to access said goods, services or promotional materials.

2. The system of claim 1, wherein said goods, services or promotional materials comprise audio products, video products, or coupons.

3. The system of claim 2, wherein said audio products, comprise music.

4. The system of claim 2, wherein said video products, comprise movies, music videos or other audio visual works.

5. The system of claim 2, wherein said coupons, comprise product or service discount coupons.

6. The system of claim 1, wherein said access to said goods, services or promotional materials is achieved by downloading said goods, services or promotional materials from the Internet or other communications network.

7. The system of claim 1, wherein said access to said goods, services or promotional materials is achieved by downloading said goods, services or promotional materials through said interface.

8. The system of claim 1, wherein said system validates said data received by said system, such that said system may allow for access to said goods, services or promotional materials no more than once.

9. The system of claim 1, wherein said user interface comprises a website.

10. The system of claim 1, wherein said user interface comprises a software application running on an electronic device.

11. The system of claim 1, wherein said interface comprises a personal computer.

12. The system of claim 1, wherein said interface comprises a mobile phone or a tablet-computer.

13. The system of claim 1, wherein said data comprises one or more of alpha numeric characters, symbols, bar codes, QR codes, or other perceptible designations or images.

14. The system of claim 1, wherein said interface comprises a bar code scanner, a photographic interface, or other device which may detect said data.

15. A method for facilitating a user's redemption of goods, services or promotional materials comprising the steps of:
receiving through a user interface data associated with an event admissions ticket;
identifying said data as valid data; and
allowing said user to access said goods, services or promotional materials.

16. The method of claim 15, further comprising the step of:
retrieving said goods, services or promotional materials.

17. The method of claim 15, further comprising the step of:
downloading said goods, services or promotional materials from the Internet and/or other communications networks.

18. The method of claim 15, further comprising the step of:
downloading said goods, services or promotional materials through said user interface.

19. The method of claim 15, wherein said data may only be validated one time.

20. The method of claim 15, wherein said goods, services or promotional materials comprise audio products, video products, or coupons.

21. The method of claim 20, wherein said audio products, comprise music.

22. The method of claim 20, wherein said video products, comprise movies, music videos or other audio visual works.

23. The method of claim 20, wherein said coupons, comprise product or service discount coupons.

24. The method of claim 15, wherein said user interface comprises a website.

25. The method of claim 15, wherein said user interface comprises a software application running on an electronic device.

26. The method of claim 15, wherein said interface comprises a personal computer.

27. The method of claim 15, wherein said interface comprises a mobile phone or a tablet-computer.

28. The method of claim 15, wherein said data comprises one or more of alpha numeric characters, symbols, bar codes, QR codes, or other perceptible designations or images.

29. The method of claim 15, wherein said interface comprises a bar code scanner, a photographic interface, or other device which may detect the bar code image.
